(19) United States
(12) Patent Application Publication
(10) Pub. No.: US 2004/0150205 A1
(43) Pub. Date: Aug. 5, 2004

(54) Ball mount storage device

(76) Inventor: Gilberto DeAnda, Tucson, AZ (US)

Correspondence Address: Gilberto DeAnda, 9715 E Deer Trail, Tucson, AZ, 85748, US

(21) Appl. No.: 10/770,177

(22) Filed: Feb. 2, 2004

Related U.S. Application Data
(60) Provisional application No. 60/444,524, filed on Feb. 3, 2003.

(51) Int. Cl. B60R 9/06

(52) U.S. Cl. 280/769

(57) ABSTRACT

A device mounted on a vehicles receiver-type hitch that is used for storing a removable ball mount when it is disengaged. It is comprised of a locking storage container (that houses a removable ball mount) and an anchor used to mount the storage container to the vehicles receiver-type hitch.

### CROSS REFERENCE TO RELATED PATENT APPLICATION

Provisional Patent: Issued Feb. 3, 2003 U.S. PTO No. 60/444524

### FIELD OF THE INVENTION

The present invention relates to ball mounts used in conjunction with a vehicles receiver-type hitch, and more particularly the storage of a ball mount.

### BACKGROUND OF THE INVENTION

It can be appreciated that ball mounts have been in use for years in conjunction with receiver-type hitches. A ball mount, in it's functional mode, projects to the rear of a vehicles bumper, unnoticed this may cause bodily injury to the lower extremities of an inattentive passer-by. Furthermore, storing an unsecured ball mount in the bed of a vehicle becomes a dangerous projectile in the event of a vehicle collision or even a sudden stop. Most vehicles lack a convenient means of storing and securing a ball mount. As a result, ball mounts are often left behind at a users home or shop. Creating a troublesome situation for retrieval.

Several designs have provided solutions to this problem in the past. The self-storing hitch: Addresses this problem by utilizing a towing hitch with a built-in storage chamber. The storage chamber houses a retractable hitch. U.S. Pat. No. 6,149,181. The stowaway, receiver hitch: It provides a mount mechanism for a receiver-type hitch system. The mount is deployable and stowable at the election of the user. U.S. Pat. No. 6,460,870.

These attempts to provide a suitable means of storing a ball mount, may prove to be to elaborate, complex, and costly, without providing a simple, clean, and cost effective, storing device.

It is therefore an object of the invention to provide a ball mount storage container that is anti-theft.

It is another object of the invention to provide multiple types of anchoring devices to accomodate a variety of receiver-type hitch systems.

It is another object of the invention to provide a convenient means of storing a ball mount on a receiver hitch, quickly and easily without altering the vehicles hitch.

Another object of the invention is to provide a ball mount storage container that will store the ball mount, so that it will not be in a position to cause bodily harm to a persons lower extremities, when not in use.

Another object is to provide a ball mount storage container that secures the ball mount so it will not become a hazardous projectile in an auto accident.

### SUMMARY OF THE INVENTION

In accordance with the present invention, the primary object is to provide a ball mount storage device that is easily installed in the end of the distal cavities of various receiver-type hitch systems. The components include, a locking storage container (that houses the ball mount) and an anchor. This anchor is designed to secure the ball mount storage container to a receiver-type hitch without modifying the vehicles hitch.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a front view of a ball mount storage container mounted to the end of the distal cavity of a vehicles receiver-type hitch.;

FIG. 2 is a side view of a ball mount storage container that stores the removable ball mount.;

FIG. 3 is a side view of an anchor. It consists of an anchor track plate, a rectangular flange, and a triangular wedge.;

FIG. 4 is a cross sectional view of an anchor, with an anchor track plate, rectangular flange, and wedge;

FIG. 5 is a perspective view of a ball mount storage container unit (with respect to the ball mount storage container attached to the anchor).;

FIG. 6 is a side view of an alternative embodiment of an anchor which consists of an anchor track plate, and a cylindrical wedge, more commonly known as a muffler pipe expander.; and

FIG. 7 is a side view of an alternative embodiment of an anchor which consists of an anchor track plate and a double wedge flange..

For purposes of clarity and brevity, like elements and components will bear the same designations and numbering throughout the FIGURES.

### DESCRIPTION OF THE PREFERRED EMBODIMENT

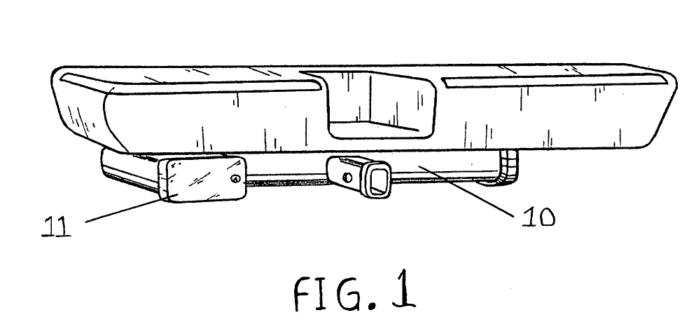

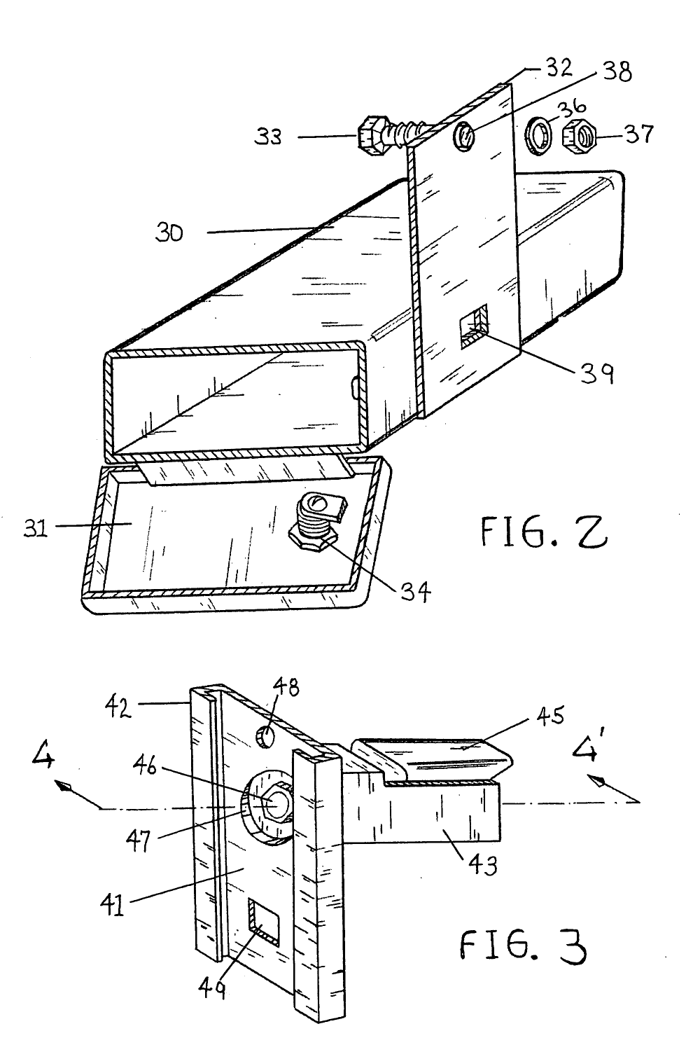

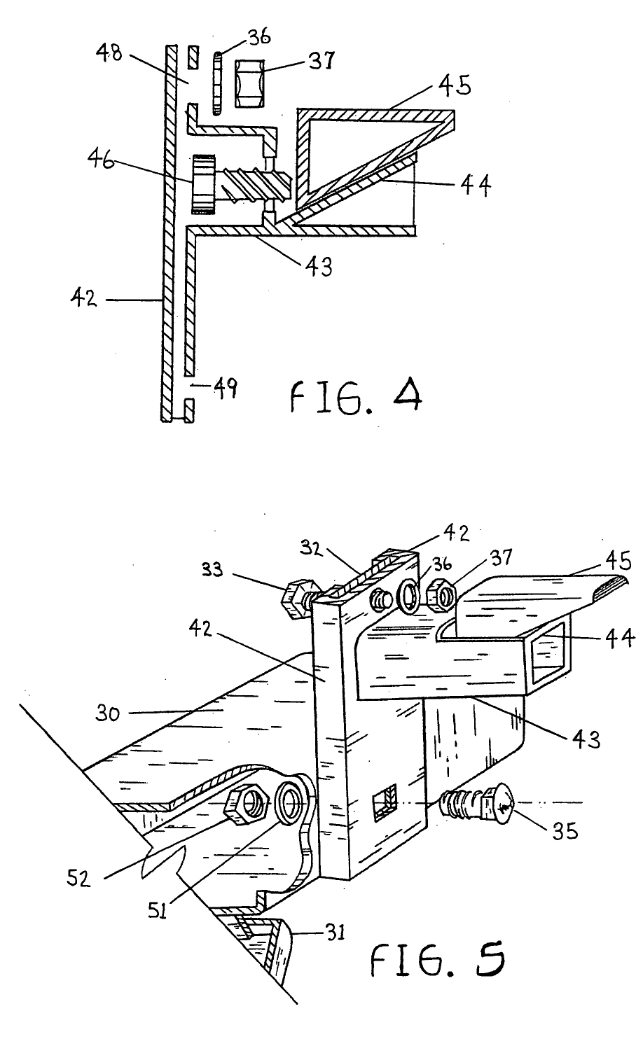

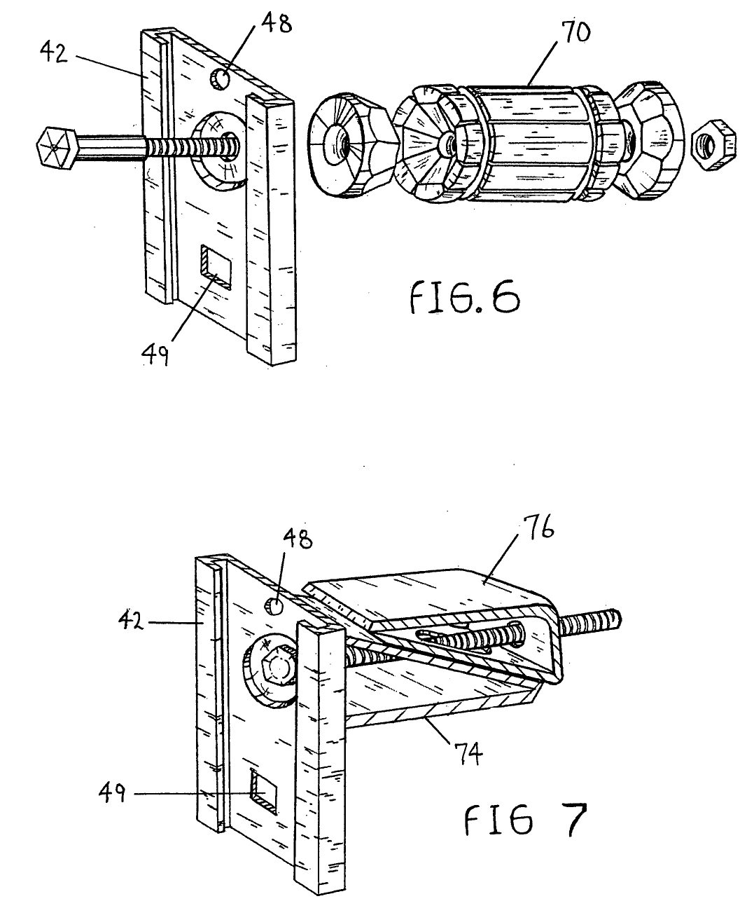

FIG. 1 is a perspective view of a vehicles receiver-type hitch 10 with a ball mount storage container unit 11 attached. The ball mount storage container unit 11 is comprised of a ball mount storage container 30, (the storage container is used to store a ball mount) and an anchor 41 whose function is to secure the ball mount container to the cavity at the distal end of a vehicles receiver-type hitch 10. FIG. 2 shows a ball mount storage container 30. The ball mount storage container 30 consists of an enclosed rectangular tube with a hinged access door 31 and mounting plate 32 (the mounting plate 32 is used to attach the ball mount storage container 30 to the anchor 41). The ball mount storage container 30 is tailored to cradle the ball mount. The access door 31 is equipped with a keyed locking mechanism 34 (this is used prevent theft of the ball mount which is inside the container). The mounting plate 32 is designed to slide into the anchor track plate 42 (the mounting plate 32 is preferably welded to the storage container). The mounting plate 32 is equipped with two alignment holes, a round alignment hole 38 and a square alignment hole 39. The square alignment hole 39 is used to secure and align the mounting plate 32 to the anchor track plate 42 using a carriage bolt 35, lock washer 36, and hex nut 37. The carriage bolt 35 is secured with the lock washer 36 and hex nut 37, from within the ball mount storage container 30, only by opening the access door 31 can the securing hex nut 52 be applied or removed. Alternatively a linch pin, or the like may be utilized. The round alignment hole 38 is a secondary hole for aligning and securing the mounting plate 32 to the anchor track plate 42 using a bolt, lock washer 36, and hex nut 37 as shown in FIG. 5. FIG. 3 shows the anchor 41, it consists of an anchor track plate 42 attached to a flange 43, and a wedge bolt 46. The anchor track plate 42 consists of a “C” shaped channel that is designed to accommodate, the width, length and thickness of the mounting plate. 32 on the ball mount storage container 30. The mounting plate 32 slides snugly into the anchor 41 track. The anchor 41 also has a recessed wedge bolt access hole 47 between the inside edges of the “C” channel of the anchor track plate 42. The wedge bolt 46 is used to engage the wedge 45. The flange 43 is a tubular component that is designed to fit into the distal cavity of a rectangular or square receiver-type hitch 10. However, there are other alternative embodiments, as shown in FIGS. 6 and 7, that are designed to function with different shaped cavities of receiver-type hitches. The exterior of the flange 43, referring to FIG. 3, is rectangular or square. The upper-half of the flange 43 (that is distal from the anchor track plate 42) is cut-away to allow free movement of the wedge 45 within the interior walls of the receiver-type hitch 10. The wedge 45 rests upon the incline plane portion 44 of the flange 43. The wedge 45 is shaped and sized to adapt to the flange 43, the wedge 45 also has the same angle of incline as the angle of incline on the interior of the flange 43. This enables the wedge 45 to travel freely upward on the inclined plane portion within the interior of the flange 43, when the wedge bolt 46 is engaged. This dimensional height increase causes the wedge 45 to be anchored within the interior walls of the receiver-type hitch 10. FIG. 4 further shows a cross sectional view of an anchor 41 with a wedge 45 resting on the inclined plane portion of the flange 43. FIG. 5 illustrates how the ball mount storage container 30 is attached to the anchor 41 and also displays the wedge 45 resting within the rectangular flange 43. FIG. 6 is an alternative embodiment of an anchor 41, used to mount the ball mount storage container 30. An anchor track plate 42 mounted with muffler pipe expander 70 is utilized to accomodate a receiver-type hitch 10 with a round cavity. . A muffler pipe expander 70 is designed to expand within the confines of round tubing, thereby establishing a solid anchor 41 attachment for the ball mount storage container 30. FIG. 7 is an alternative embodiment of an anchor 41 that can be used with a rectangular or square receiver-type hitch 10. It consists of an anchor track plate 42 and a double wedge flange 72. The double wedge flange 72, is comprised of two wedges that are of like parallel inclined planes. The wedges are connected and engaged by a bolt which traverses the parallel inclined planes. The distal wedge 76 is fitted with a hex nut 37, or other threaded material, that allows the traversing bolt to engage the distal wedge 76 against the anchor track plate 42 wedge 45. When the bolt is tightened, the distal wedge 76 slides up the inclined plane portion, causing a dimensional height increase and wedging the flange 43 within the interior walls of the receiver-type hitch 10.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A ball mount storage device for providing a locking storage container that attaches to a vehicles receiver hitch. comprising:
means for storing a removable ball mount;
means for safeguarding the removable ball mount;
means for locking the ball mount storage container. again, pins, latches and other fasteners may substitute;
means for sliding the ball mount storage container into the anchor track plate;
means for aligning and securing the mounting plate to the anchor track plate with a carriage bolt, lock washer and hex nut. again, pin, latches and other fasterners may substitute;
means for providing secondary alignment hole for fastening the mounting plate to the anchor track plate with a bolt, lock washer and hex nut. again, pins, latches, and other fasterners may substitute;
means for providing a track that receives the mounting plate connected to the ball mount storage container;
means for providing a tubular shaped piece (that may take alternative shapes) to fit into the receiver-type hitches distal cavity;
means for providing a wedge to secure the flange within the interior walls of the receiver-type hitch;
means for engaging the wedge against the interior walls of the receiver-type hitch cavity;
means for providing access to the wedge bolt;
means for providing a secondary alignment opening for the anchor plate and the mounting plate with a bolt lock washer and hex nut. again, pins, latches and other fasteners may substitute;
means for aligning the anchor track plate to the mounting plate with a carriage bolt, lock washer and hex nut. again, pins, latches and other fasteners may substitute;
means for providing an expanding anchor to accomodate the cavity of a round tubing receiver-type hitch;
means for providing an alternative anchoring device for the ball mount storage container;
means for providing the first half of the double wedge flange; and
means for providing the second half of the double wedge flange.

2. The ball mount storage device in accordance with claim 1, wherein said means for storing a removable ball mount comprises a ball mount storage container.

3. The ball mount storage device in accordance with claim 1, wherein said means for safeguarding the removable ball mount comprises an access door.

4. The ball mount storage device in accordance with claim 1, wherein said means for locking the ball mount storage container. again, pins, latches and other fasteners may substitute comprises a keyed locking mechanism.

5. The ball mount storage device in accordance with claim 1, wherein said means for sliding the ball mount storage container into the anchor track plate comprises a mounting plate.

6. The ball mount storage device in accordance with claim 1, wherein said means for aligning and securing the mounting plate to the anchor track plate with a carriage bolt, lock washer and hex nut. again, pin, latches and other fasterners may substitute comprises a square alignment hole.

7. The ball mount storage device in accordance with claim 1, wherein said means for providing secondary alignment hole for fastening the mounting plate to the anchor track plate with a bolt, lock washer and hex nut. again, pins, latches, and other fasterners may substitute comprises a round alignment hole.

8. The ball mount storage device in accordance with claim 1, wherein said means for providing a track that receives the mounting plate connected to the ball mount storage container comprises an anchor track plate.

9. The ball mount storage device in accordance with claim 1, wherein said means for providing a tubular shaped piece (that may take alternative shapes) to fit into the receiver-type hitches distal cavity comprises a flange.

10. The ball mount storage device in accordance with claim 1, wherein said means for providing a wedge to secure the flange within the interior walls of the receiver-type hitch comprises a wedge.

11. The ball mount storage device in accordance with claim 1, wherein said means for engaging the wedge against the interior walls of the receiver-type hitch cavity comprises a wedge bolt.

12. The ball mount storage device in accordance with claim 1, wherein said means for providing access to the wedge bolt comprises a wedge bolt access hole.

13. The ball mount storage device in accordance with claim 1, wherein said means for providing a secondary alignment opening for the anchor plate and the mounting plate with a bolt lock washer and hex nut. again, pins, latches and other fasteners may substitute comprises a round alignment opening.

14. The ball mount storage device in accordance with claim 1, wherein said means for aligning the anchor track plate to the mounting plate with a carriage bolt, lock washer and hex nut. again, pins, latches and other fasteners may substitute comprises a square alignment opening.

15. The ball mount storage device in accordance with claim 1, wherein said means for providing an expanding anchor to accomodate the cavity of a round tubing receiver-type hitch comprises a muffler pipe expander.

16. The ball mount storage device in accordance with claim 1, wherein said means for providing an alternative anchoring device for the ball mount storage container comprises a double wedge flange.

17. The ball mount storage device in accordance with claim 1, wherein said means for providing the first half of the double wedge flange comprises an anchor track wedge.

18. The ball mount storage device in accordance with claim 1, wherein said means for providing the second half of the double wedge flange comprises a distal wedge.

19. A ball mount storage device for providing a locking storage container that attaches to a vehicles receiver hitch. comprising:
a ball mount storage container, for storing a removable ball mount;
an access door, for safeguarding the removable ball mount;
a keyed locking mechanism, for locking the ball mount storage container. again, pins, latches and other fasteners may substitute;
a mounting plate, for sliding the ball mount storage container into the anchor track plate;
a square alignment hole, for aligning and securing the mounting plate to the anchor track plate with a carriage bolt, lock washer and hex nut. again, pin, latches and other fasterners may substitute;
a round alignment hole, for providing secondary alignment hole for fastening the mounting plate to the anchor track plate with a bolt, lock washer and hex nut. again, pins, latches, and other fasterners may substitute;
an anchor track plate, for providing a track that receives the mounting plate connected to the ball mount storage container;
a flange, for providing a tubular shaped piece that may take alternative shapes) to fit into the receiver-type hitches distal cavity;
a wedge, for providing a wedge to secure the flange within the interior walls of the receiver-type hitch;
a wedge bolt, for engaging the wedge against the interior walls of the receiver-type hitch cavity;
a wedge bolt access hole, for providing access to the wedge bolt;
a round alignment opening, for providing a secondary alignment opening for the anchor plate and the mounting plate with a bolt lock washer and hex nut. again, pins, latches and other fasteners may substitute;
a square alignment opening, for aligning the anchor track plate to the mounting plate with a carriage bolt, lock washer and hex nut. again, pins, latches and other fasteners may substitute;
a muffler pipe expander, for providing an expanding anchor to accomodate the cavity of a round tubing receiver-type hitch;
a double wedge flange, for providing an alternative anchoring device for the ball mount storage container;
an anchor track wedge, for providing the first half of the double wedge flange; and
a distal wedge, for providing the second half of the double wedge flange.

20. A ball mount storage device for providing a locking storage container that attaches to a vehicles receiver hitch. comprising:
a ball mount storage container, for storing a removable ball mount;
an access door, for safeguarding the removable ball mount;
a keyed locking mechanism, for locking the ball mount storage container. again, pins, latches and other fasteners may substitute;
a mounting plate, for sliding the ball mount storage container into the anchor track plate;
a square alignment hole, for aligning and securing the mounting plate to the anchor track plate with a carriage bolt, lock washer and hex nut. again, pin, latches and other fasterners may substitute;
a round alignment hole, for providing secondary alignment hole for fastening the mounting plate to the anchor track plate with a bolt, lock washer and hex nut. again, pins, latches, and other fasterners may substitute;
an anchor track plate, for providing a track that receives the mounting plate connected to the ball mount storage container;
a flange, for providing a tubular shaped piece that may take alternative shapes) to fit into the receiver-type hitches distal cavity;
a wedge, for providing a wedge to secure the flange within the interior walls of the receiver-type hitch;
a wedge bolt, for engaging the wedge against the interior walls of the receiver-type hitch cavity;
a wedge bolt access hole, for providing access to the wedge bolt;
a round alignment opening, for providing a secondary alignment opening for the anchor plate and the mounting plate with a bolt lock washer and hex nut. again, pins, latches and other fasteners may substitute;
a square alignment opening, for aligning the anchor track plate to the mounting plate with a carriage bolt, lock washer and hex nut. again, pins, latches and other fasteners may substitute;
a muffler pipe expander, for providing an expanding anchor to accomodate the cavity of a round tubing receiver-type hitch;
a double wedge flange, for providing an alternative anchoring device for the ball mount storage container;
an anchor track wedge, for providing the first half of the double wedge flange; and
a distal wedge, for providing the second half of the double wedge flange.
